(19) United States
(12) Patent Application Publication
(10) Pub. No.: US 2025/0378445 A1
(43) Pub. Date: Dec. 11, 2025

(54) METHODS FOR PAYMENT AND MERCHANT SYSTEMS WITH ADVANCED CANCELATION FUNCTIONALITY

(71) Applicant: SUPERTAB AG, Steinhausen (CH)

(72) Inventors: Cosmin-Gabriel ENE, Zollikon (CH); Marcel ERNI, Zug (CH)

(21) Appl. No.: 18/874,703

(22) PCT Filed: Jun. 16, 2023
(86) PCT No.: PCT/EP2023/066297

§ 371 Date: Dec. 13, 2024

Related U.S. Application Data
(60) Provisional application No. 63/352,805, filed on Jun. 16, 2022.

(51) Int. Cl. G06Q 20/40; G06Q 30/0207; G06Q 40/03

(52) U.S. Cl. CPC G06Q 20/4016; G06Q 20/405; G06Q 20/407; G06Q 30/0224; G06Q 40/031

(57) ABSTRACT

Methods for payment and merchant systems which facilitates the payment of small monetary amounts, making the payment more secure for the user. A payment system for at least one online shop relies on an identifier of a user device for recording at least one identification number of the user device, for receiving and confirming direct debit orders, and for storing the direct debit orders. Such method monitors the total of the debit amounts in relation to the identification number and to request a user of the user device to register after a predetermined time interval and/or on exceeding a predetermined value of the total payable, in order to settle at least part of the total payable. Such payment system methods further provide unique solutions of canceling purchases, detecting abusers of cancelations, awarding trust tokens, and providing a quality measure of the digital content, and the merchant offering such content.

### FIELD OF THE INVENTION

The invention generally relates to methods for payment and merchant systems which facilitate payment of small monetary amounts by a user for the purchase of, for example, digital content or subscriptions for digital content, making the payment more secure for the user, and specifically, unique solutions in connection with such payment methods of canceling purchases or subscriptions by detecting abusers of cancelations, and measures to be taken against individuals who abuse cancelations of digital content and/or subscriptions, and the tracking of cancelations for determining user and merchant satisfaction indicators, and processes and actions based on such indicators for improving quality of the digital content items offered by merchant.

### BACKGROUND

Shopping systems are known wherein a plurality of web servers is mutually connected via a network, usually the internet, in order to enable a purchaser to purchase goods and/or services. Conventionally, the customer selects a particular virtual marketplace, seeks goods and services there, places them in a virtual shopping trolley and pays for the items at the end of the shopping procedure. The payment procedure is usually very complex, since it is necessary for the individual user or purchaser to be sufficiently authenticated. For this purpose, the name and address are usually requested. For the payment transaction, the user must enter account or credit card information which enables debiting of the payable amount. The process of registration, that is, input of name and address and/or account or credit card information is complex. A main problem lies therein that with small amounts from a few cents to a Euro (€0.01 to €1.00), customers are reluctant to register at all. The effort involved in order to obtain goods or information for a few cents on the market place is too great and is out of proportion to what is being purchased. Thus for payments in the region of under €1, there is no actual market, since it cannot come into existence due to the effort-to-reward ratio.

Additionally, the individual users would like to ensure that their data will be treated confidentially. Usually, users will only disclose their information when they trust the marketplace in question. It is therefore difficult for small businesses to establish such marketplaces or online shops.

For the monetary processing of purchases, service providers have now become established which offer payment systems with which one needs only to register once, in order then to be able to carry out corresponding payment transactions in numerous online shops via one such service provider. The registration for such central payment systems is again very complex. Furthermore, such a payment transaction incurs costs which, inter alia, the online shops must bear.

It is apparent overall that the obstacles and starting thresholds associated with such a purchase on the internet are so numerous and high that potential purchasers are often deterred from making such a purchase. This applies, in particular, for goods and services for the purchase of which only very small sums are involved. It is extremely problematic, for example, to demand full registration of a user in order to view a one-page test report which costs about 50 cents.

The inventor of the present invention conceived this payment system which ensures a secure payment transaction for use with, for example, a corresponding shopping system and a method for performing a plurality of payment transactions, as described in U.S. application Ser. No. 15/806,945, filed Nov. 8, 2017, granted as U.S. Pat. No. 11,170,378 on Nov. 9, 2021, which is a continuation-in-part of U.S. application Ser. No. 14/283,885 filed May 21, 2014, which is a divisional of U.S. application Ser. No. 13/394,485 filed Mar. 6, 2012, now pending, which is a U.S. national phase of PCT Application No. PCT/EP2010/005435 filed Sep. 3, 2010, which claims priority to DE 102009050985.2 filed Oct. 28, 2009 and DE 102009040575.5 filed Sep. 8, 2009, all the disclosures of which are hereby incorporated in their entirety by reference herein.

In particular, such payment system for at least one online shop system comprises: an identification device for recording at least one identification number of a shopper system; an interface device for receiving and confirming direct debit orders from the at least one online shop, wherein the debit orders comprise information relating to a debit amount, i.e., price, to be paid to the online shop; a memory device for storing the direct debit orders in conjunction with the associated identification numbers; a processing device which is configured to monitor the total of the debit amounts in relation to the identification number and to request a user of the shopper system to register after a predetermined time interval and/or on exceeding a predetermined value of the total payable, in order to settle at least part of the total payable.

An essential concept of such payment system is that it records a purchase made by a user in the form of a direct debit order, and also stores identification information which enables the preferably unique identification, i.e., identifier, of the shopper system used. Initially, therefore, no information is requested regarding the user of the shopper system. Theoretically, any user could carry out shopping and payment transactions with the shopper system.

Once a predetermined time interval has passed and/or a predetermined value of the total payable has been exceeded, that payment system requests the user to register in order to pay at least part of the total payable. The user can thus meanwhile shop entirely anonymously and completely secure against fraud. The individual purchases are associated with the shopper system used by him, for example, a user device such as a PC or a mobile communication device. Only once a predetermined period has elapsed or a predetermined total payable has been amassed, does the user have to disclose his identity or at least input information which enables settlement of the debt.

The payment system lowers to a minimum the entry threshold for chargeable content on the internet, since it enables the user to consume now and pay later. The user can accumulate a plurality of very small payable amounts (micro payments) and then pay these as soon as a relevant amount has accumulated. This also saves technical resources, since the associated measures do not have to be performed for every minimal payment transaction. Furthermore, a new market can be accessed with the payment system, such as the market which deals with payments characterised by very small monetary amounts (e.g. smaller than €1). Such payment system also make the processing of small payments economical. The minimum debit handling charges of banks are sometimes multiple times higher than the value of the content purchased (e.g. on average €0.20 per transaction). Such payment system can serve as a global shopping trolley (e.g. over a plurality of web sites) and can aggregate purchases. These are then settled cumulatively, thus reducing the relative charges per transaction to a minimum. The direct debit transaction is processed only once for e.g. 20 purchases, reducing the incidental costs incurred for performance of the direct debit. The processing device can be configured such that, until registration, said system does not request any personal data and, in particular, no payment information from the user of the shopper system prior to sending a system of the online shop an authorization signal representing that the payment system does not perceive the shopper system as uncreditworthy.

The methods of such payment system facilitate payment of small monetary amounts by a user for the purchase of, for example, digital content or subscriptions for digital content, making the payment more secure for the user. Moreover, an improvement to such payment system described herein are unique solutions for canceling purchases or subscriptions and detecting and taking measures against individuals who abuse cancelations of digital content and/or subscriptions.

The identification device can provide a program which can be executed on the shopper system to record the at least one identification number. The communication protocol itself often enables the recording of a suitable label, which preferably uniquely identifies the shopper system. However, a program which reads or generates a suitable identification number to identify the shopper system and can be executed on the shopper system is preferably provided.

The interface device can comprise a blacklist of identification numbers and can be configured such that said device refuses direct debit orders relating to an identification number contained in the blacklist, whilst the processing device can be configured to store in the blacklist identification numbers of shopper systems the users of which do not register after the predetermined time interval and/or on exceeding the predetermined total payable to settle the total payable at least partially. It is therefore possible for the present payment system to exclude persons or users who are bad payers and thereby minimise the resulting loss. Since the payment system is preferably used for settling very small debit amounts, the financial risk is very slight.

The shopping system can comprise at least one online shop, such as a network-accessible merchant, with a system such as a web server, to provide, for example, an HTML-based sales portal, wherein at least one object is embedded in the sales portal for processing debit orders and has a communication link to the payment system. An interaction between the online shop and the sales portal is therefore possible without the user having to instigate additional measures for this purpose. The online shop embeds a suitable object, i.e., executable software code, in the internet presence of said shop, i.e., the software code, such as HTML code, for providing the online shop's webpage(s), and handles the payment processes via the object, which communicates with the payment system

The embedded object can be configured for outputting information regarding the payment system, particularly a payment demand and/or an account balance. The user needs therefore to make no further effort to view his account balance with the payment system. The relevant information is presented as part of the internet presence of the individual online shops. In the event, also, that the payment system wishes to send out information to the user, the payment system does not need to take any active steps. Rather, the occasion when the user, using his shopper system, visits an online shop communicating with the payment system can be awaited. In this event, the online shop issues suitable information for the payment system to the user of the shopper system.

Such method for carrying out a plurality of payment transactions, may comprise: storage of an identification number of a shopper system, user device, by means of which a purchase is transacted in an online shop in the amount of a particular purchase sum, storage by a payment system of the purchase sum, e.g., price, in conjunction with the identification number, monitoring by the payment system of the total payable from the purchases transacted by means of the shopper system transmitting an authorization signal to the merchant system, and issuing, to a user of the shopper system, of a request for settlement of at least part of the total payable when said total payable exceeds a predetermined value and/or after a predetermined time interval has elapsed.

The method may alternatively comprise registration of a user following issuing of the request. Therefore, unlike the conventional system, there is no immediate registration for settlement of each purchase sum. Rather, the payment system accumulates purchase sums over a relatively long time period and then, only later, requests settlement.

Registration can comprise the recording of bank account and/or credit card information.

The aforementioned identification number can be a hardware identification number. It is preferably a hardware identification number of the shopper system. Such identification numbers are a fixed component of conventional shopper systems and can be used for the unique identification thereof. It is also relatively complex to amend such numbers such that the payment system according to the invention is deceived.

The hardware identification number can comprise at least part of an MAC (Media-Access-Control) address and/or a processor identification number and/or a hard disk identification number and/or an IP address and/or other unique device numbers, e.g. the Unique Device Identifier (UDID) of a Smartphone.

The identification of the shopper system can take place using just the hardware identification number. Optionally, other mechanisms can be provided to identify the user and/or the shopper system. For example, a ‘local shared object’ can be placed on the shopper system. This object can be a Flash cookie. In order to secure this identifier against falsification, the object can be digitally signed. The signature can be realised by means of a certificate from a Public Key Infrastructure (PKI).

The time interval can be, for example, greater than 10 days and/or greater than 1 month and/or greater than three months. Preferably, the time interval is calculated from the entry or execution of a first debit order in relation to a particular identification number onwards.

However, the above-described payment systems do not address or disclose methods for cancelation of ordered downloadable digital content and/or subscriptions after the order is placed, e.g., within a few minutes, several hours, days or weeks after such placement of an order. Moreover, it is not readily discernable how such cancelation could be achievable in view of the communication exchange that occurs between the user, merchant and payment systems, especially in view of that the user is unknown until an account is created. Moreover, the above-described payment systems do not provide descriptions of the manner in which to detect and address abusers of cancelations of ordered downloadable digital content and subscriptions for downloadable content several hours or days.

### SUMMARY OF THE INVENTION

The present disclosure provides additional functionality that is missing from the existing methods of payment systems conceived by the present inventors described in the above-referenced disclosures, wherein such additional functionality enables users to cancel purchases or subscriptions of digital content, and provides methods of detection and implementation measures against users who abuse cancelations of digital content and/or subscriptions to digital content services.

In accordance with an exemplary embodiment of the disclosed payment system method, a processor of such payment system (a) receives, over a network, an identifier of a user device and information indicative of a price of a requested item for purchase from a network-accessible merchant by the user device: (b) determines, based on the user device identifier, a credit worthiness indicator associated with the user device; (c) transmits an authorization signal to the network-accessible merchant for the requested item without concurrently requiring payment for the purchase when the creditworthiness indicator satisfies predetermined conditions; (d) monitors a total outstanding purchase balance associated with the user device; (e) transmits a request signal to the user device for settlement of at least a part of the total outstanding purchase balance associated with the user device identifier when the total outstanding purchase balance exceeds a predetermined threshold amount: (f) in response to receiving a cancelation request from the user device, performing a determination of a cancelation abuse indicator associated with the user device identifier based on a least one of a time duration since acceptance of a grant of the purchase request for the item, number of prior cancelations, time period over which the number of prior cancelations has occurred, time interval since last cancelation, the credit worthiness indicator, frequency of prior cancelations, and whether the user device identifier is included in a maintained list of abuser device identifiers; and (g) based on the determined cancelation abuse indicator, performs a determination of whether to grant or deny such cancelation request.

The present disclosure provides further additional functionality, wherein such additional functionality enables the determination of user satisfaction indicators and merchant satisfaction indicators based on the tracking of canceled purchases or subscriptions of digital content items, and performs other actions for notifying users and merchants regarding those digital content items and merchants with higher cancelation rates to make informed decisions, as well as transmitting notice indicative of the indicators to network servers providing internet search services, which may affect ranking of search results of such digital content.

In accordance with an exemplary embodiment of the disclosed payment system method directed to determining and use of user satisfaction indicators, a processor of such payment system (a) receives over a network, an identifier of a user device and information indicative of a price of a requested digital content item for purchase from a network-accessible merchant by the user device; (b) monitors a total outstanding purchase balance associated with the user device; (c) transmits an authorization signal to the network-accessible merchant for the requested digital content item without concurrently requiring payment for the purchase when a total outstanding purchase balance associated with the user device does not exceed a predetermined threshold amount: (d) transmits a request signal to the user device for settlement of at least a part of the total outstanding purchase balance associated with the user device identifier when the total outstanding purchase balance exceeds the predetermined threshold amount and transmitting an authorization signal to the network-accessible merchant for the requested digital content item in response to receiving payment of at least a part of the total outstanding purchase balance associated with the user device identifier; (e) determines a user satisfaction indicator for the purchased digital content item based on at least one of tracking (i) number of purchases of the digital content item by a plurality of user devices including the user device; (ii) number of granted cancelations to the plurality of user devices of such purchased digital content, and (iii) number of purchases for which such digital content was forwarded by at least one of the plurality of user devices to another user device; and based on the determined user satisfaction indicator; and (f) based on the determined user satisfaction indicator, performs at least one other action of transmitting a notice indicative of the user satisfaction indicator to the merchant offering such digital content item, preparing a notice indicative of the user satisfaction indicator for transmission to user devices subsequently seeking to purchase such digital content item using the payment system, limiting a number of authorization signals subsequently transmitted to the merchant for the requested digital content item, and transmitting a notice indicative of the user satisfaction indicator for that digital content item to a network server providing an internet search service.

In accordance with an exemplary embodiment of the disclosed payment system method directed to determining and use of merchant satisfaction indicators, a processor of such payment system (a) receives over a network, an identifier of a user device and information indicative of a price of a requested digital content item for purchase from a network-accessible merchant by the user device; (b) monitors a total outstanding purchase balance associated with the user device; (c) transmits an authorization signal to the network-accessible merchant for the requested digital content item without concurrently requiring payment for the purchase when a total outstanding purchase balance associated with the user device does not exceed a predetermined threshold amount; (d) transmits a request signal to the user device for settlement of at least a part of the total outstanding purchase balance associated with the user device identifier when the total outstanding purchase balance exceeds the predetermined threshold amount and transmitting an authorization signal to the network-accessible merchant for the requested digital content item in response to receiving payment of at least a part of the total outstanding purchase balance associated with the user device identifier; (e) determines a merchant satisfaction indicator based on at least one of tracking (i) a number of purchases of a plurality of digital content items from the merchant by a plurality of user devices including the digital content requested by the user device; (ii) a number of granted cancelations to the plurality of user devices of such purchased plurality of digital content items, (iii) a number of purchases for which at least one of the plurality of digital content items was forwarded by at least one of the plurality of user devices to another user device, and (iv) a number of user devices of the plurality of user devices that purchase more than one digital content items of the plurality of digital content items from the merchant; and (f) based on the determined merchant satisfaction indicator, performs at least one other action of transmitting a notice indicative of the merchant satisfaction indicator to the merchant offering such digital content item, preparing a notice indicative of the merchant satisfaction indicator for transmission to user devices subsequently seeking to purchase one of the plurality of digital content items offered by the merchant using the payment system, limiting a number of authorization signals to be subsequently transmitted to the merchant for the requested digital content items available from the merchant, and transmitting a notice indicative of the merchant satisfaction indicator to network server providing an internet search service.

Further embodiments are disclosed in the sub claims.

### BRIEF DESCRIPTION OF THE DRAWINGS

The invention will now be described in greater detail using several exemplary embodiments and making reference to the drawings, in which:

FIG. 1 shows a shopping system comprising a shopper system, an online shop and a payment system;

FIG. 2 shows the individual components of an exemplary embodiment of the payment system of FIG. 1;

FIG. 3 shows exemplary database entries of the payment system of FIGS. 1 and 2; and

FIG. 4 shows a flow diagram of an exemplary order-making process according to the disclosure.

FIG. 5 shows a flow diagram of an exemplary process that enables detection of users that abuse their exercising of cancelations of purchased items, and exemplary measures that may be taken against such users in subsequent cancelations in accordance with the disclosure.

FIG. 6 shows a flow diagram of an exemplary process for determining an advantageous user satisfaction indicator and merchant status indicator for performing further respective actions.

In the following description, the same reference signs are used for the same and similarly acting parts.

### DETAILED DESCRIPTION

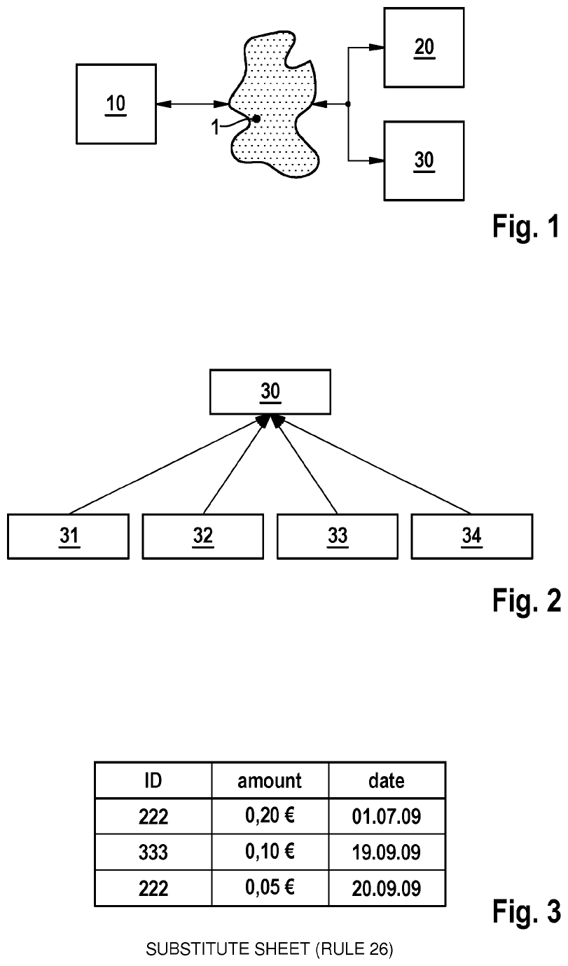

FIG. 1 shows the shopping system according to the invention. Herein a shopper system 10, for example, a user device such as a laptop, a PC or a mobile terminal is connected via a network, in the present case the internet 1, to an online shop 20 such as, for example, a network-accessible merchant. The online shop 20 and the shopper system 10 are also in communicative connection, via the internet 1, with the payment system 30. Normally, numerous other systems are connected to the internet 1.

FIG. 2 shows individual components of the payment system 30. The payment system 30 according to the invention has an identification device 31 for recording at least one identifier, i.e., identification number of the shopper system 10, an interface device 32 for receiving and confirming direct debit 6 orders from the online shop 20, wherein the debit orders comprise information relating to a debit amount to be paid, i.e., purchase price, to the online shop 20, a memory device 32 for storing the direct debit orders in conjunction with the associated identification numbers ID and a processing device 34 for processing the incoming payment transactions.

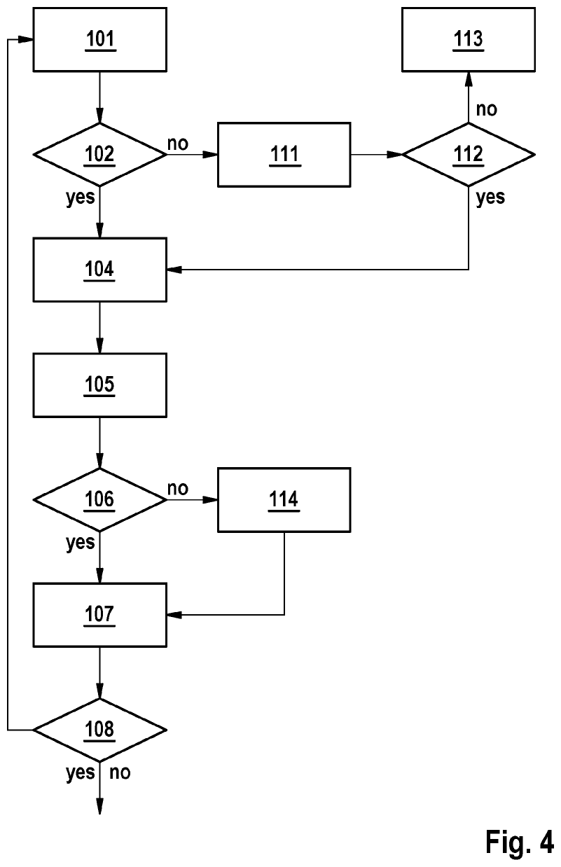

The individual devices will now be described in greater detail by reference to the flow diagram in FIG. 4. An exemplary embodiment of a purchase processed by the payment system 30 according to the invention proceeds as follows:

A user enters particular internet addresses into the shopper system 10 operated by him, in the browser running therein. The browser establishes contact with the server(s) of the online shop 20 and represents an internet presence of the online shop 20. This internet presence contains an embedded object which is in communicative connection with the interface device 32 of the payment system 30. The payment system 30 can therefore record an identification number ID of the shopper system 10 by means of the embedded object. In the present case, for example, this is an MAC address of the shopper system 10. Thus, as made clear in step 101 of FIG. 4, the MAC address of the shopper system 10 is recorded.

It is subsequently checked whether the shopper system 10 is creditworthy (step 102) by, for example, determining a creditworthiness indicator. Such determination may be made by, for example, the payment system 30, and particularly the processing device 34, determining whether an account exists for the received MAC address. If a corresponding account exists, it is determined whether debit amounts have already been added to this account. If this is the case, the individual debit amounts are totaled. If the debit amounts do not exceed a predetermined amount (e.g. €3), or if the oldest debit order was incurred more than a predetermined time period ago, for example, three months, a creditworthiness indicator is generated satisfying a predetermined condition enabling the payment system 30 to transmit an authorization signal to the online shop 20 indicating that it is user to continue with its purchase (step 104).

However, if the debit amounts exceed the predetermined amount (e.g. €3), or if the oldest debit order was more than a predetermined time interval, for example, three months ago, the user of the shopper system 10 is requested to settle the added debit amounts (step 111). If the user pays the outstanding total payable (step 112), the creditworthiness indicator is generated satisfying the predetermined condition enabling the payment system 30 to transmit an authorization signal to the online shop that enables the user to continue with its purchase (step 104). Otherwise, the creditworthiness indicator is generated that would not satisfy the predetermined conditions and no authorization signal would be transmitted by the payment system 30 to the online shop 20, i.e., alerting the online shop 20 to deny the user for its requested purchase (step 113).

Moreover for determination of the creditworthiness indicator, the payment system 03 may additionally verify whether the identifier of the shopper system 10 is included in a maintained blacklist of identifiers of user devices which, for example, do not register after the predetermined time interval and/or exceed the predetermined total payable without settlement. Such blacklist may include user identifiers of shopper systems for other reasons including, for example, such identifiers represent stolen user devices, devices located or originated from outside of a specific territory or an embargoed country or region.

Accordingly, if the creditworthiness of the shopper system 10 is acceptable, the transmitted authorization signal alerts the online shop 20 that the user can make the requested purchase by means of the shopper system 10 (step 104). For example, a chargeable review of a cinema film or other digital content can be accessed. In another exemplary embodiment, the user can be enabled to undertake a telephone call over the internet 1, or activate or reserve a variety of other services.

In connection with completion of the purchase, for example, the online shop 20 passes the associated booking in the form of a direct debit order to the payment system 30, particularly to the interface device 32 (step 105). In step 106, it is checked whether an account already exists for the shopper system 10. In effect, it is determined whether an account has already been established by the payment system 30 for the read-out MAC address. If no account exists, a suitable account is established (step 114). In step 107, the payment system 30 (in particular the memory device 33) stores the direct debit order in conjunction with the MAC address. An entry which gives information about which purchases have already been transacted with the recorded MAC address is therefore added to the created account.

The user of the shopper system 10 can then decide whether he wishes to undertake more purchases (step 108). If the user wishes, he can call up a further internet presence of a further online shop 20 by input of a further internet address. Then the recording of his MAC address is carried out once again and this is then passed on to the payment system 30 (step 101).

As the above exemplary embodiment makes clear, initially, the payment system 30 records the individual direct debit orders as anonymously as possible. The payment system 30 confirms each debit order to the online shop 20, such as by, for example, an authorization signal, so that the online shop 20 can essentially assume a completed payment. The payment system 30 can identify the shopper system 10 based purely on the MAC address.

The memory device 33 thus stores the direct debit order in conjunction with the corresponding MAC address. For this purpose, the payment system 30 comprises a corresponding database in which corresponding tables are kept. An exemplary extract from a table kept therein is shown in FIG. 3. Said table comprises, for example, three columns, specifically a first column which contains the identification of a particular direct debit order, a second column which contains the amount to be debited and a third column which contains the date on which the direct debit order was received by the payment system 30. Each line of the table in FIG. 3 corresponds to a direct debit order. Thus, it is possible to read from the table in FIG. 3 that on Jan. 7, 2009, 20 Eurocents were debited for identification number 222. Furthermore, on 20 Sep. 2009, 5 Eurocents were debited for the same MAC address.

The processing device 34 can use these entries to determine the total payable from the debit amounts for particular identification numbers ID. For example, the total payable for identification number 222 comes to 25 Eurocents.

Thus, the payment system 30 can be configured, for example, so that a user of a shopper system 10 has to settle his debts when they are greater than €1. Accordingly, in step 102 it is checked, for the user of the shopper system with the identification number 222, whether the total payable already amassed by said system is greater than €1. Since this is not the case in the exemplary embodiment shown in FIG. 3, the creditworthiness indicator is generated satisfying the predetermined condition enabling the payment system 30 to transmit an authorization signal to the online shop 20 to enable the user to make further purchases without having to settle his debts.

In the exemplary embodiment described above, in step 102, it is checked whether the shopper system 10 has already amassed a total payable that is greater than a particular value (for example, €1). In addition, the processing device 34 can check in step 102 whether the user of the shopper system 10 has used the payment system 30 for longer than a particular predetermined time interval. For example, the processing device 34 can check whether the first direct debit order of a particular identification number ID is older than 3 months. The payment system 30 can be configured such that in this case, an immediate demand for settlement of the outstanding amounts is issued.

The payment system 30 can also be configured such that said system offers the user the possibility to settle his amassed direct debit orders at any time. Preferably, the user is encouraged, by the offering of rebates, to make his actual payment to the payment system 30 at as early a time point as possible.

The payment system 30 can also comprise an account monitoring device which monitors actual incoming payments, and credits them to a shopper system 10. For example, a registration according to the invention can take place therein that the user enters a user name. In exchange, the payment system 30 shows him an account number and requests him to transfer the total payable to the corresponding account, stating his user name. The transferred amount is then credited to the account of the shopper system 10 used by him.

In a further exemplary embodiment, the user name or a payment reason reference is automatically generated. The user therefore remains as anonymous as possible.

In another exemplary embodiment, the user can input address data and his actual name and, together with these data, enter his account number, so that the payment system 30 can debit the direct debit orders amassed in the past. The entries can also be used to perform future direct debit orders either in the short term or in the form of a batch debit at the end of a month, a quarter, or a year.

In the exemplary embodiments described above, an MAC address was used to identify the shopper system 10. It should be obvious for a person skilled in the art that, in place of the MAC address, he can use an IP address, an identification number of an operating system, an identification number of a processor or other identification numbers that give access to the identity of the shopper system 10. It is also theoretically possible to use a plurality of these identification numbers ID in order to increase the reliability of the payment system 30. Furthermore, it is possible to use just parts of said identification numbers to generate a unique key which identifies the shopper system 10.

Also, the payment system 30 may be configured to additionally receive from the online shop 20 information regarding the requested item for purchase by the shopper system 10, and further evaluate whether the user device has previously been provided access to such requested item.

In the exemplary embodiment according to FIG. 1, a shopping system is defined with only one shopper system 10 and only one online shop 20. Usually a plurality of shopper systems 10 access one online shop 20. Furthermore, a plurality of online shops 20 is present, which use one or more payment systems 30 according to the invention.

Exemplary embodiments have been described above wherein identification of the shopper system 10 is directed to a particular identification number ID which gives an MAC address, an IP address, an identification number of an operating system, an identification number of a processor or other identification numbers which give access to the identity of the shopper system 10, or comprises parts thereof. It is possible to undertake a combination of the methods. Therefore different identification numbers ID, relating, for example, to an MAC address or an IP address or an identification number of a processor can be requested. Finally, the identification numbers ID which are provided by the shopper system 10 are used.

It is also possible to request individual identification numbers ID according to a sequence. This sequence can be based on the probability with which a particular shopper system 10 provides the numbers or the character string. Thus the payment system 30 can first search for an MAC address. If this cannot be determined, then the processor identification number, or the like, is requested. It is also conceivable for a cookie to be set.

The user can thus be uniquely assigned a database by means of a digitally signed cookie. The signed data can comprise a combination value formed from all the previously known user data in order to make misuse more difficult. The cookie can be stored using a plurality of techniques on the shopper system 10 (e.g. as a HTTP or Flash Cookie) and thus, as far as possible, be secured against later deletion. If, on a later contact with the payment system 30, the cookie is deleted in a cookie store, it can be created anew. The cookie can also comprise a parameter which states whether the user is already registered or logged in. The user can log into an interface of the payment system 30 at any time in order to inspect his account information.

In a further embodiment of the invention, the payment system 30 can use a code provided by the user in order to identify himself to the payment system. The code can serve as an identification number ID and be used in place of a hardware identification number, for example, the MAC address, of the shopper system 10. It is also conceivable that the code input for the above-mentioned identification numbers ID, for example, a requested hardware identification number, is used.

The code can be, for example, an IMSI (International Mobile Subscriber Identity). The user of the shopper system 10 enters the IMSI of his mobile telephone and the payment system 30 establishes an account relating thereto or adds the debit amounts to the existing account. The payment system 30 can verify the correctness of the code given-that is, the IMSI-in that said payment system sends a message, for example, by SMS (Short Message Service) to the relevant mobile telephone. The payment system 30 can then request the user to confirm receipt of the message, for example, by returning the message or input of a code, wherein use of the payment system 30 is prohibited if the message is not confirmed. Said verification can only take place once, preferably on establishment of the account, or at every payment transaction.

In order to minimise as far as possible the risk of non-paying users (for example: a user uses the payment system 30 until he is requested to settle his debts. He then fails to settle his debts, but dispenses with further use of the payment system 30), the payment system 30 can comprise an evaluation device for contributing to and/or generation of the creditworthiness indicator. Said evaluation device records statistical data concerning the direct debit orders and/or the identification numbers ID issued, preferably continuously. Further data which provide information concerning the type of purchases made and/or the location of the user can be recorded and evaluated. For example, the IP address of the user can be used in order to determine roughly his location. Furthermore, using the IP address of the internet providers used by the user, an individual with RIPE responsibility or the like can be determined. The evaluation device can use the collected statistical data to adapt the payment threshold.

For example, a user to whom, on the basis of his IP address, a group having statistically good creditworthiness is assigned, can undertake direct debit orders until his account has a negative balance of more than €2, whereas a user to whom, on the basis of his IP address, a group having poor creditworthiness is assigned, can only undertake direct debit orders up to a total payable of €1. Theoretically, the payment system 30 can entirely prevent a debit before the registration if the user is assigned to a group with very poor creditworthiness. The statistics are maintained by the evaluation device, preferably in a database, and can be analysed accordingly on first contact with the user, and used for determination of the creditworthiness indicator.

As explained above, the identification number ID can at least partially comprise or be derived from data stored in a cookie and kept in the shopper system 10. Preferably, the relevant data are stored multiple times on the shopper system 10, in order to prevent deletion of said data. For example, a plurality of cookies can be stored in the shopper system 10, wherein a first cookie is stored therein directly by the payment system 30 and a second cookie is stored there by means of the online shop 20. The payment system 30 can thus request the identification number ID directly from the shopper system 10 and compare the requested value with a value provided by the online shop 20. In order to increase security and anonymity, the identification number ID can be made available to the online shop 20 in an encoded form, so that it is not possible for the online shop 20 to make a direct allocation of the user to a particular identification number ID. As soon as the user visits the same online shop 20 once again, said shop requests the identification number ID and passes said number on to the payment system. The shopper system 10 can also be directed to a web site of the payment system 30, said web site requesting the further cookie with a further, or the same, identification number ID.

For a person skilled in the art in this field, it should be obvious that there are further possibilities for allocating the identification number ID to the shopper system 10. For example, the communication protocols on which the internet is based can be amended such that said protocols permit unambiguous conclusions about the shopper system used. Commonly used browsers employ caching of the requested web sites in order to be able to access said web sites rapidly and easily. It is necessary to provide individually cached elements with a (web) identification number so that on renewed call-up of a site by the shopper system 10, an updated version of the object provided with the identification number is requested. This request by the shopper system 10 enables the payment system 30 to identify the shopper system 10 uniquely. URLs can also be modified so that said URLs give the identification number ID or a portion thereof.

The disclosed payment service was described with the functions of the payment system 30 separate from the functions of the online shop 20. However, it readily should be understood that such payments systems may be incorporated into the operations of the online shop. For example, the operations of such an online shop may include: receiving, over a network, request information and an identifier of a shopper system, wherein the request information represents a request for transmission of specific digital content to said the shopper system, with the digital content transmission subject to a fee; further receiving information from the shopper system indicating acceptance of the fee for such digital content; storing information related to the fee in association with the shopper system identifier; monitoring a total outstanding balance of fee(s) associated with the user device identifier; transmitting a request signal for settlement of at least a part of the total outstanding purchase balance when the total outstanding fees balance exceeds a predetermined threshold amount or when the total outstanding fees over a period of time exceeds a predetermined time interval; and transmitting the requested specific digital content to said user device when the total outstanding fees balance does not exceed the predetermined threshold amount or the total outstanding fees over a period of time does not exceed the predetermined time interval.

### Advanced Cancelation Functionality

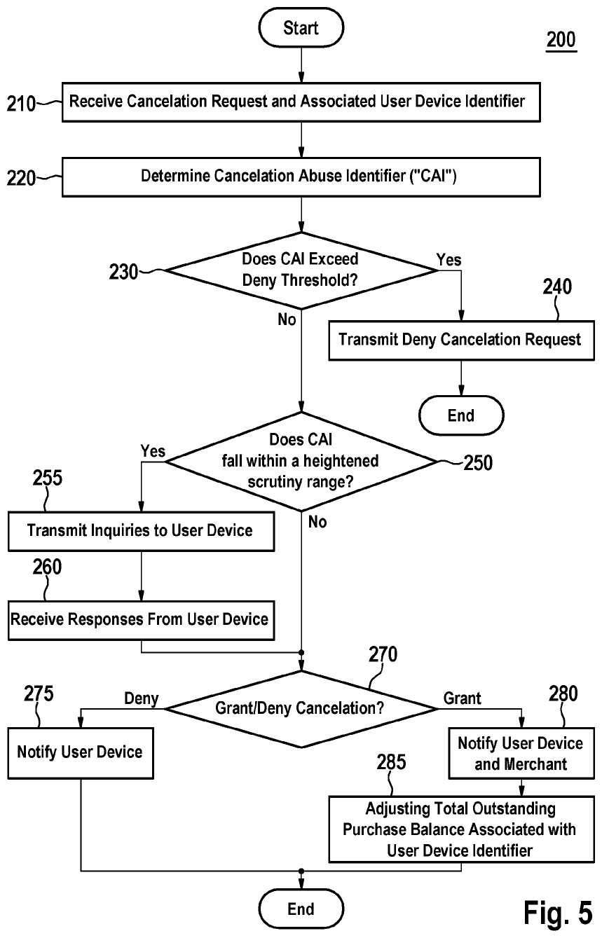

FIG. 5 depicts a flow-diagram of an advantageous exemplary cancelation process 200 useable with the payment system of the present disclosure. In FIG. 5, the process 200 begins in step 210 with receipt of a cancelation or refund request from a user device that includes the user device identifier. In response to receiving this, the payment system performs, in step 220, determining a cancelation abuse identifier value (“CAI”) for the received user device identifier. The CAI for the user device identifier may be based on a least one of, for example, a time duration since acceptance of a grant of the purchase request for the item, number of prior cancelations, time period over which the number of prior cancelations has occurred, time interval since last cancelation, the credit worthiness indicator, frequency of prior cancelations, and whether the user device identifier is included in a maintained list of abuser device identifiers.

Upon determination of the CAI, the payment system then determines, in step 230, whether the CAI exceeds a deny threshold value. If the deny threshold value is exceeded, then the process 200 transmits a deny-cancelation-request message to the user device in step 240, and the process 200 ends. In the alternative, if the CAI does not exceed the deny threshold value in step 230, the payment then determines if the CAI is within a heightened scrutiny range in step 250. If the CAI is within such range, the process 200 proceeds to step 255 and transmits certain inquiries to the user device in connection with, for example, the satisfaction of the requested item, order request/purchase, and/or reasons for cancelation. Exemplary inquiries useable for transmission to the user device in step 255 include, for example: “We see you do not like this digital content, please elaborate regarding why so the publisher can improve its offers” or “Why would you like to return this content? Your answer will help to improve quality.”

The corresponding responses entered by the user and transmitted by the user device in reply to the inquiries transmitted in step 255 are then received by the payment system in step 260. In the alternative, if the process 200 determines in step 250 that the CAI is not within the heighted scrutiny region, the process 200 proceeds directly to step 270.

In step 270, the process 200 determines whether to grant or deny the cancelation request based on whether the CAI is not within the heighted scrutiny from step 250, or based on whether the responses to the inquiries are then received in step 260 satisfy certain criteria. If in step 270, it is determined to deny the cancelation request, the step 275 is performed by notifying by transmitting to the user device a deny-cancelation-request message accordingly. Conversely, if in step 270, it is determined to grant the cancelation request, step 280 is performed to notify user device that the cancelation request has been accepted, and to notify the merchant of the granted cancelation, which effectively informs the merchant that they will not receive any funds for the canceled item. It advantageous to perform the determination of step 270 to grant or deny such cancelation in substantial absence of (a) identifying a user associated with the user device or its identifier, (b) registration or login to the payment system or to the network-accessible merchant computer by a user associated with the user device or its identifier; and/or (c) whether the network-accessible merchant transmitted the item to the user device or its identifier.

After step 280 is performed, the process 200 proceeds to step 285 and adjusts the outstanding purchase balance associated with the user device identifier before ending such process. In accordance with the process 200, the cancelation may be advantageously independent of (a) whether the user device received the requested item of digital content or subscription under which digital content was provided to the user device; (b) whether the user device confirms deletion of any digital content received for the canceled item; and/or (c) in substantial absence of receipt of payment by the payment system.

As described above, one option for the determination of the CAI in step 220 is to advantageously base such CAI, at least in part, on the number of prior cancelation requests associated with that user device identifier in the total aggregate and/or over a particular time period, e.g., a number of days or months, such that as the number of prior cancelation requests increases, the CAI will increase potentially into the range of heightened scrutiny, or above the deny threshold.

In one particular exemplary embodiment, the CAI may be based on a user cancelation request ratio, e.g., the ratio of the number of requested cancelations associated with a user device identifier (or a user) over a period of time (such as, for example, one day, one week, one month or six months). Such user cancelation request ratio may be compared against a general user cancelation request ratio, wherein the general user cancelation request ratio may be based on, for example, a ratio of all user devices (or users) globally or within a particular geographic region, relative to the number of purchases made using the payment system over that period of time by such users. If such CAI slightly exceeds the general user cancelation request ratio by a predetermined amount, e.g., up to 15%, digital content items from the merchant would be subject to heightened scrutiny in step 250 of FIG. 3, or if the CAI far exceeds the general user cancelation request ratio by the predetermined amount, then such user's cancelation request would be denied in steps 270, 275 of FIG. 3.

In another exemplary embodiment, the above-described CAI would be based on a user session cancelation request ratio, e.g., the ratio of the number of requested cancelations associated with a user device identifier (or a user) in at least one of a predetermined duration of time, e.g., specific time interval, or time of a single session during the user device is interacting with a website or group of websites, relative to the number of purchases made during such predetermined duration of time using the payment system.

A cancelation ratio for a particular digital content item, e.g., the ratio of the number of granted cancelations associated for that digital content item relative to a number of granted user cancelations for all digital content items in a predetermined category of digital content items, e.g., digital publishing, may be useful as a basis for one factor of a user satisfaction indicator as described below.

By tracking the cancelations of specific digital content items, and cancelations with regard to digital content items offered by a respective merchant, such as a publisher, the payment system can use such information as factors for assessing the quality of such digital content items, and merchants. Such assessed quality of the digital content or merchants is particularly advantageous where the cancelations occur within a day, a week, a month or up to six months, of the date of purchase.

The rate of cancelations of purchased digital content items from a particular merchant may be useful as a factor of a merchant satisfaction indicator of the quality of such digital content items offered by that merchant, whereby a low rate of cancelations may be indicative of the offering of higher quality digital content items, and a high rate of cancelations may be indicative of the offering of lower quality digital content. One exemplary method for quantizing the quality of the digital content items offered by a merchant is to determine a merchant cancelation request ratio for that merchant based on a ratio of the number of requested cancelations for that particular merchant over a period of time (such as, for example, one, three or six months), over that same period of time.

The merchant cancelation request ratio may also be useful as a measure of quality of that merchants offered digital content items, in the form of a merchant satisfaction indicator based on, for example, a comparison of the merchant cancelation request ratio to a category request ratio based on, for example, the ratio of the number of requested returns overall for merchants in the same predetermined category of digital content items as the merchant's (such as, for example, digital publishing), relative to the number of purchases digital content items from all, or a representative portion of, merchants in that predetermined category made using the payment system over the same period of time.

Such merchant satisfaction indicator may be used by the payment system, for example, to limit or otherwise moderate the number of transmitted authorization signals for purchases requested by user devices in instances in which the merchant cancelation request ratio exceeds a category cancelation request ratio by a predetermined percentage, for example, 25% or more, until such merchant's merchant satisfaction indicator improves. Further, if one or more items of digital content, or digital content offered by a particular merchant are subject to an exceedingly high numbers of cancelation requests, the payment system may cease transmitting authorization signals for purchases of such items of digital content items, or digital content items offered by such merchant.

In an alternative embodiment, if the merchant cancelation request ratio exceeds the category cancelation request ratio by first predetermined percentage range of, for example, 15% to 25%, an automated or manual alert may be transmitted to the merchant that it is experiencing high cancelation rates generally or for a specific data content item, as the case may be, in conjunction with lowering the percentage of authorization signals transmitted by the payment system for the purchase of digital content items from that merchant to, for example, 50% of its then current authorization signal transmission rate. The message to the merchant may suggest the merchant consider to cease offering digital content items experiencing the high cancelation rates, or to reduce the price of those digital content items where cancelation feedback has indicated that the price of such digital content items was too high.

Then, if the merchant cancelation request ratio continues to increase relative to the category cancelation request ratio by a second percentage range of, for example, 25% to 35%, a second notification will be transmitted to the merchant accordingly, in conjunction with lowering the percentage of authorization signals provided by the payment system for the purchase of digital content items from that merchant will be reduced to, for example, 25% of its then current rate. Further, if the merchant cancelation request ratio continues to further increase relative to the category cancelation request ratio to greater than, for example, 35%, the payment system will cease transmitting authorization signals to the merchant for requests for digital content offered by that merchant.

The quality of the digital content items may further be based on other advantageous user satisfaction indicators for digital content purchases including, for example, tracking the instances where (a) the user device does not cancel a purchase, but forwards or otherwise shares such digital content with other user devices; (b) the user device does not cancel and does not forward or share the digital content with other users; and (c) a high cancelation rate occurs for particular digital content items. These user satisfaction indicators are likewise useable for the merchant satisfaction indicators for a merchant offering such digital content items. One other merchant satisfaction indicator is the number of times user devices make multiple purchases of digital content items from a particular merchant within predetermined time period or periods, such as a day, a week, a month or up to six months, of the date of a first or subsequent purchase.

The purchase of digital content without cancelation by a user indicates a level of satisfaction with the purchased digital content by that user, while the purchase of digital content and forwarding same by the user is often indicative of a relatively higher level of satisfaction by the user. In like manner, the purchase of digital content from a merchant without cancelation by a user indicates a level of satisfaction with the digital content offered by that merchant, while the forwarding of purchased digital content from a merchant or purchases of more than one digital content item same by the user is a predetermined time period is often indicative of a relatively higher level quality of digital content offered by that merchant.

Based on the determined user satisfaction indicator, a processor of the payment system may perform at least one other action of (i) transmitting a notice indicative of the user satisfaction indicator to the merchant offering such digital content item, (ii) preparing a notice indicative of the user satisfaction indicator for transmission to user devices subsequently seeking to purchase such digital content item using the payment system, (iii) limiting a number of authorization signals subsequently transmitted to the merchant for the requested digital content item, and (iv) transmitting a notice indicative of the user satisfaction indicator for that digital content item to a network server providing an internet search service.

It is possible for the user satisfaction indicator to be based on, for example, a numerical or star rating system implemented by the payment system. In such example, a 5 star or 5 point user satisfaction indicator may be used wherein 5 stars or 5 points are awarded for each purchase of a digital content item (that are not canceled) that are forwarded or shared with another user device (or user), while 4 stars or 4 points are awarded for each purchase of a digital content item not canceled or forwarded, and 1 star or 1 point (or 0 stars or 0 points) is awarded for each grant of a cancelation request of a purchased digital content item. An average rating may then be based on the result of the sum of all the points or stars awarded for a digital content item divided by the number of purchases of such digital content item.

Such rating system may further be used in connection with the merchant satisfaction indicator, but with the addition of also awarding 5 stars or 5 points when a user device purchases multiple digital content items (that are not canceled) within a period of time of, for example, a day, a week, a month or up to six months.

Based on the determined user satisfaction indicator, the payment system may perform at least one other action of (i) transmitting a notice indicative of the merchant satisfaction indicator to the merchant, (ii) preparing a notice indicative of the merchant satisfaction indicator for transmission to user devices subsequently seeking to purchase one of the plurality of digital content items offered by the merchant using the payment system, (iii) limiting a number of authorization signals to be subsequently transmitted to the merchant for the requested digital content items available from the merchant, and transmitting a (iv) notice indicative of the merchant satisfaction indicator to network server providing an internet search service.

Further, the quality of the purchased digital content and/or the associated merchant may further be based on responses received from user devices in reply to short questionnaires that may be displayed in response to cancelation requests that includes a question, for example, of “why is the user attempting to cancel such digital content purchase?” Exemplary response options may include i) bad quality, ii) too expensive, iii) not addressing the topic I thought the digital content would cover; and/or iv) other.

As described above, a notice indicative of the user satisfaction indicator and/or merchant satisfaction indicator may, for example, be transmitted to network services providing internet search services, such as services available from, for example, Google LLC, Microsoft Corp. or Apple Inc., to effect a ranking and where digital content from such merchant may appear in the list of results generated in response to search query requested by a user device. For example, this advantageous quality measure may be useable as a resource for the ranking engine of the search systems and methods described in U.S. Pat. No. 9,002,832, which is incorporated by reference herein in its entirety. Information indicative of the user satisfaction indicator and/or merchant satisfaction indicator may also be, for example, provided in the search results presented to the user device to enable its user to make an informed decision regarding whether to purchase certain digital content items.

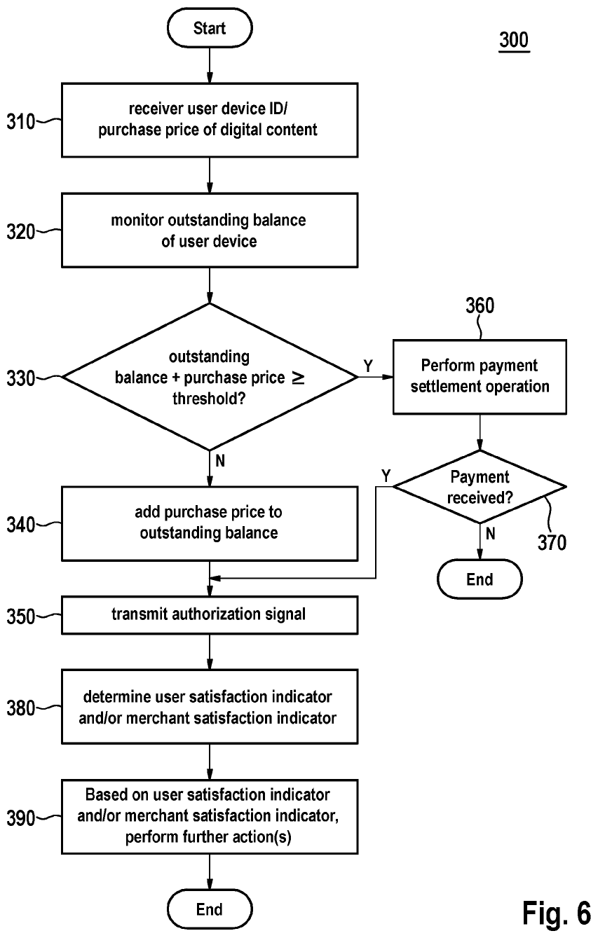

FIG. 6 depicts a flow diagram of an exemplary method 300 for determining and advantageously using the user satisfaction indicator and/or merchant satisfaction indicator for the benefit of the users in identifying and purchasing higher quality content and those merchants offering higher quality content. Referring to FIG. 6, in step 310, the payment system receives over a network, e.g., the internet, an identifier of a user device and information indicative of a price of a requested digital content item for purchase from a network-accessible merchant by that user device. Then, in step 320, the payment system monitors the outstanding balance that may be owed by the user device.

In step 330, the payments system determines whether the sum of the outstanding balance owed by the user device (or the user of a known user is associated with the user device) and the received purchase price for the digital content of interest exceeds a predetermined threshold amount, e.g. €3. If in step 330, it is determined that the calculated sum does not exceed the predetermined threshold amount, the method likewise proceeds to step 340 where the purchase is added to the outstanding balance owed to become an updated outstanding balance owed, and then, in step 350, the payment system transmits the authorization signal to the merchant for providing the user device with the digital content of interest.

However, if in step 330, it is determined that the sum of the outstanding balance owed by the user device and the received purchase price for the digital content of interest exceeds the predetermined threshold amount, the method likewise proceeds to step 360 for the performance of a settlement operation as described above for payment of at least part of the balance owed. Then, in step 370, if it is determined that no or insufficient payment is received the method 300 ends. Otherwise, if in step 370, it is confirmed that sufficient payment is received by the payment system, the method 300 proceeds to step 350 for transmission of the authorization signal to the merchant for providing the user device with the digital content of interest.

After transmitting the authorization signal in step 350, the method 300 determines the user satisfaction indicator and/or merchant satisfaction indicator as described above in step 380. The user satisfaction indicator for the purchased digital content item may be based on at least one of tracking (i) number of purchases of the digital content item by a plurality of user devices including the user device; (ii) number of granted cancelations to the plurality of user devices of such purchased digital content, and (iii) number of purchases for which such digital content was forwarded by at least one of the plurality of user devices to another user device.

Similarly, the determined merchant satisfaction indicator may be based on at least one of tracking (i) a number of purchases of a plurality of digital content items from the merchant by a plurality of user devices including the digital content requested by the user device; (ii) a number of granted cancelations to the plurality of user devices of such purchased plurality of digital content items, (iii) a number of purchases for which at least one of the plurality of digital content items was forwarded by at least one of the plurality of user devices to another user device, and (iv) a number of user devices of the plurality of user devices that purchase more than one digital content item from the merchant.

It should be understood that step 380 may be performed shortly after step 350, or after a period of time to enable a user of the user device to determine if they wish to cancel the purchase, which may be on the order of serval minutes, e.g., 30 minutes, hours, e.g., 4 to 12 hours, or days, e.g., 1 to 14 days. In addition, the step 380 may advantageously be performed periodically or intermittently by the payment system to account for a sufficient number purchases and cancelations by many user devices to increase the amount of data processed for determining the user satisfaction indicator and/or merchant satisfaction indicator.

After the determination of the user satisfaction indicator and/or merchant satisfaction indicator in step 380, the method 300 proceeds to step 390, where based on the user satisfaction indicator and/or merchant satisfaction indicator, the payment system advantageously performs further actions to benefit the users and merchants. For example, with regard to the determined user satisfaction indicator, the payment system may perform at least one other action of (i) transmitting a notice indicative of the user satisfaction indicator to the merchant offering such digital content item, (ii) preparing a notice indicative of the user satisfaction indicator for transmission to user devices subsequently seeking to purchase such digital content item using the payment system, (iii) limiting a number of authorization signals subsequently transmitted to the merchant for the requested digital content item, and (iv) transmitting a notice indicative of the user satisfaction indicator to a network server providing an internet search service.

Correspondingly, with regard to the determined merchant satisfaction indicator, the payment system may perform at least one other action of transmitting a notice indicative of the merchant satisfaction indicator to the merchant offering such digital content item, preparing a notice indicative of the merchant satisfaction indicator for transmission to user devices subsequently seeking to purchase one of the plurality of digital content items offered by the merchant using the payment system, limiting a number of authorization signals to be subsequently transmitted to the merchant for the requested digital content items available from the merchant, and transmitting a notice indicative of the merchant satisfaction indicator to network server providing an internet search service.

After step 390, the method 300 ends.

The determination and tracking of the user satisfaction indicators and merchant satisfaction indicators and the above-noted actions to be taken based on such indicators incentives merchants to only provide digital content of higher quality and at a fair prices. The user is incentivized to cancel purchases of digital items of poor quality or excessively priced without any adverse consequences (assuming such user is not abusing such cancelations), and further may optionally be awarded redeemable trust tokens for her/his actions as further described below.

Further in regard to the method 200 of FIG. 5, the payment system (or merchant offering the digital content or subscription utilizing such payment system) may provide alternative options to the user rather than just denying the user's cancelation request in steps 240 and/or step 275, and may instead or in addition use such cancelation request to enable increase business for the payment system and/or merchant, and/or build trust with such user. To this end, rather than denying the user's cancelation request, the payment system may provide options to the user to encourage the user to further interact with the payment system or other entities via the payment to build such trust including, for example, inviting the user to (a) answer certain questions related and/or unrelated to the digital content to be canceled; (b) share his/her payment system account, or certain purchased digital content with friends and/or family and providing the payment system with contact information therefor; (c) take a payment system or third party survey; and/or (d) take some other or further action. To the extent that the user agrees to and successfully follows through with one or more of these exemplary options, such user is perceived to be building trust with the payment system and thereby the payment system may (i) grant the user's request for cancelation and then performs steps 280 and 285; and/or (ii) grant to the user or user device a number of “trust tokens” (analogous to reward points.

Such trust tokens may then be used for acquiring free or discounted digital content and/or subscriptions, future cancelation of one or more purchases of digital content and/or subscriptions, and/or other benefits. Additional trust tokens may further be earned by the user or user device achieving threshold millstones for purchasing digital content/subscriptions, sharing digital content/subscriptions with a specified number of friends and/or family; or sharing the user's payment system for use by friends and/or family. Trust tokens may further be earned by a user device or user contributing information regarding quality of digital content offered by merchants, such contribution being in the form of canceling purchased digital content items that were subject to high cancelation rates. In this manner, the user is rewarded for making the payment system aware of low quality digital content. These options are intended to incentivize the use of the payment system by the user or her/his friend and family, and/or the lawful collection of useful data.

The payment system may further optionally limit when a user may request a cancelation including, for example, enabling a cancelation request (a) within a certain time period after purchase of the digital content, e.g., minutes, hours or days; (b) for a limited number of items purchased over a particular time duration, e.g., cancelation limit of three items over two weeks, or relative to the total number purchased, e.g., only one out of ten purchased items; and/or (c) for only a percentage of its purchase price, e.g., refund or credit of only 80% of the purchase price.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “processor” and “data processing apparatus” encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

The term “engine” refers to one or more software modules implemented on one or more computers in one or more locations that collectively provide certain well-defined functionality, which is implemented by algorithms implemented in the modules. The software of an engine can be an encoded in one or more blocks of functionality, such as a library, a platform, a software development kit, or an object. An engine can be implemented on any appropriate types of computing devices, e.g., servers, mobile phones, tablet computers, notebook computers, music players, e-book readers, laptop or desktop computers, PDAs, smart phones, or other stationary or portable devices, that includes one or more processors and computer-readable media. Additionally, two or more engines may be implemented on the same computing device or devices.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

It is to be understood that the invention is not limited to the particular embodiments of the invention described above, as variations of the particular embodiments may be made and still fall within the scope of the appended claims.

The invention is further described by the following numbered paragraphs:
1. A computer-implemented method for a payment system comprising the steps of:
   receiving, over a network, an identifier of a user device and information indicative of a price of a requested item for purchase from a network-accessible merchant by the user device;
   determining, based on the user device identifier, a credit worthiness indicator associated with the user device;
   transmitting an authorization signal to the network-accessible merchant for the requested item without concurrently requiring payment for the purchase when the creditworthiness indicator satisfies predetermined conditions;
   monitoring a total outstanding purchase balance associated with the user device;
   transmitting a request signal to the user device for settlement of at least a part of the total outstanding purchase balance associated with the user device identifier when the total outstanding purchase balance exceeds a predetermined threshold amount;
   in response to receiving a cancelation request from the user device, performing a determination of a cancelation abuse indicator associated with the user device identifier based on a least one of a time duration since acceptance of a grant of the purchase request for the item, number of prior cancelations, time period over which the number of prior cancelations has occurred, time interval since last cancelation, the credit worthiness indicator, frequency of prior cancelations, and whether the user device identifier is included in a maintained list of abuser device identifiers; and
   based on the determined cancelation abuse indicator, performing a determination of whether to grant or deny such cancelation request.
2. The computer implemented method of paragraph 1, wherein the step of performing a determination of a cancelation abuse indicator associated with the user device identifier such that it will be more likely that the cancelation request will be denied as the number of prior cancelations requests increases for such user device identifier.
3. The computer implemented method of paragraph 1, prior to the step of performing the determination of granting or denying the cancelation request, performing the step of determining whether additional information is required from the user device based on the determined cancelation abuse indicator.
4. The computer implemented method of paragraph 3, further comprising transmitting one or more inquiries to the user device based on a result of performing the determination of whether additional information is required from the user device prior to granting or denying such cancelation request, wherein the step of performing the determination of whether to grant or deny such cancelation request is based on at least based on additional information received from the user device.
5. The computer implemented method of paragraph 3, wherein the one or more inquiries to the user device is for user feedback concerning the item.
6. The computer implemented method of paragraph 1, wherein when granting such cancelation request, adjusting the total outstanding purchase balance associated with the user device identifier accordingly for such canceled item and transmitting a notification to the merchant of such cancelation.
7. The computer-implemented method of paragraph 1, wherein when such cancelation request is granted, adjusting the total outstanding purchase balance associated with the user device identifier accordingly in substantial absence of receipt of payment by the payment system, wherein said item is digital content.
8. The computer-implemented method of paragraph 1, wherein the total outstanding purchase balance associated with the user device identifier is adjusted in substantial absence of a signal from the user device confirming deletion of the item.
9. The computer-implemented method of claim 1 wherein the step of performing the determination of whether to grant or deny such cancelation request is performed in substantial absence of registration or login to the payment system or to the network-accessible merchant computer by a user associated with the user device.
10. The computer-implemented method of paragraph 1, wherein the step of performing the determination of whether to grant or deny such cancelation request is performed in substantial absence of identifying a user associated with the user device.
11. The computer-implemented method of paragraph 1, wherein the step of performing the determination of whether to grant or deny such cancelation request is performed in substantial absence of whether the network-accessible merchant transmitted the item to the user device, wherein the item is digital content or subscription to a digital service.
12. The computer-implemented method of paragraph 1, further comprising the step of inviting the user to at least one of (a) answer certain questions related or unrelated to the digital content to be canceled; (b) share his/her payment system account or certain purchased digital content with friends and/or family and providing the payment system with their contact information; (c) take a third party survey; and/or (d) take some other or further action.
13. The computer-implemented method of paragraph 12 wherein to the extent that the user agrees to and successfully follows through with one or more of the invited items, granting to the user at least one of (i) the user's request for cancelation; and/or (ii) a number of trust tokens.
14. The computer-implemented method of paragraph 13 wherein the trust tokens may be exchanged for free or discounted digital content and/or subscriptions, and/or enabling a future cancelation one or more purchases of digital content/or subscriptions, and/or other benefits.
15. The computer-implemented method of paragraph 1 wherein the step of performing a determination of a cancelation abuse indicator associated with the user device identifier is based on a ratio of the number of requested cancelations associated with a user device identifier in at least one of a predetermined duration of time and a session of time that the user device is interacting with a website or group of websites, relative to the number of purchases made during such session using the payment system
16. A computer-implemented method for a payment system comprising the steps of:
   receiving, over a network, an identifier of a user device and information indicative of requested item for purchase from a network-accessible merchant by the user device;
   determining, based on the user device identifier, a creditworthiness indicator associated with the user device;
   transmitting an authorization signal to the network-accessible merchant for the requested purchase without concurrently requiring payment for the purchases, when the creditworthiness indicator satisfies predetermined conditions;
   monitoring a total outstanding purchase balance associated with the user device;
   transmitting a request signal to the user device for settlement of at least a part of the total outstanding purchase balance when the total outstanding balance has been accrued over a period of time that exceeds a predetermined time interval;
   in response to receiving a cancelation request from the user device, performing a determination of a cancelation abuse indicator associated with the user device identifier based on a least one of a time duration since acceptance of a grant of the purchase request for the item, the total number of prior cancelations, time interval since last cancelation, the credit worthiness indicator, frequency of prior cancelations, and whether the user device identifier is included in a maintained list of abuser device identifiers; and
   based on the determined cancelation abuse indicator, performing a determination of whether to grant or deny such cancelation request.
17. The computer implemented method of paragraph 16, wherein the step of performing a determination of a cancelation abuse indicator associated with the user device identifier such that it will be more likely that the cancelation request will be denied as the number of prior cancelations requests increases for such user device identifier.
18. The computer implemented method of paragraph 16, prior to the step of performing the determination of granting or denying the cancelation request, performing the step of determining whether additional information is required from the user device based on the determined cancelation abuse indicator.
19. The computer implemented method of paragraph 18, further comprising transmitting one or more inquiries to the user device based on a result of performing the determination of whether additional information is required from the user device prior to granting or denying such cancelation request, wherein the step of performing the determination of whether to grant or deny such cancelation request is based on at least based on additional information received from the user device.
20. The computer implemented method of paragraph 18, wherein the one or more inquiries to the user device is for user feedback concerning the item.
21. The computer-implemented method of paragraph 16, further comprising the step of inviting the user to at least one of (a) answer certain questions related or not related to the digital content to be canceled; (b) share his/her payment system account or certain purchased digital content with friends and/or family and providing the payment system with their contact information; (c) take a third party survey; and/or (d) take some other or further action.
22. The computer-implemented method of paragraph 21 wherein to the extent that the user agrees to and successfully follows through with one or more of the invited items, granting to the user at least one of (i) the user's request for cancelation; and/or (ii) a number of trust tokens.
23. The computer-implemented method of paragraph 22 wherein the trust tokens may be exchanged for free or discounted digital content and/or subscriptions, and/or enabling a future right to cancel one or more purchases of digital content, and/or other benefits.
24. The computer implemented method of paragraph 16, wherein when granting such cancelation request, adjusting the total outstanding purchase balance associated with the user device identifier accordingly for such canceled item and transmitting a notification to the merchant of such cancelation.
25. The computer-implemented method of paragraph 24, wherein when such cancelation request is granted, adjusting the total outstanding purchase balance associated with the user device identifier accordingly in substantial absence of receipt of payment by the payment system, wherein said item is digital content.
26. The computer-implemented method of paragraph 24, wherein the total outstanding purchase balance associated with the user device identifier is adjusted in substantial absence of a signal from the user device confirming deletion of the item.
27. The computer-implemented method of paragraph 16 wherein the step of performing the determination of whether to grant or deny such cancelation request is performed in substantial absence of registration or login to the payment system or to the network-accessible merchant computer by a user associated with the user device.
28. The computer-implemented method of paragraph 16, wherein the step of performing the determination of whether to grant or deny such cancelation request is performed in substantial absence of identifying a user associated with the user device.
29. The computer-implemented method of paragraph 16, wherein the step of performing the determination of whether to grant or deny such cancelation request is performed in substantial absence of the network-accessible merchant transmitted the item to the user device, and wherein the item is digital content or subscription to a digital service.
30. The computer-implemented method of paragraph 16 wherein the step of performing a determination of a cancelation abuse indicator associated with the user device identifier is based on a ratio of the number of requested cancelations associated with a user device identifier in at least one of a predetermined duration of time and a session of time that the user device is interacting with a website or group of websites, relative to the number of purchases made during such session using the payment system
31. A computer-implemented method for a payment system comprising the steps of:
   receiving, over a network, an identifier of a user device and information indicative of a price of a requested digital content item for purchase from a network-accessible merchant by the user device;
monitoring a total outstanding purchase balance associated with the user device;
   transmitting an authorization signal to the network-accessible merchant for the requested digital content item without concurrently requiring payment for the purchase when a total outstanding purchase balance associated with the user device does not exceed a predetermined threshold amount;
   transmitting a request signal to the user device for settlement of at least a part of the total outstanding purchase balance associated with the user device identifier when the total outstanding purchase balance exceeds the predetermined threshold amount and transmitting an authorization signal to the network-accessible merchant for the requested digital content item in response to receiving payment of at least a part of the total outstanding purchase balance associated with the user device identifier;
   determining a user satisfaction indicator for the purchased digital content item based on at least one of tracking (i) number of purchases of the digital content item by a plurality of user devices including the user device; (ii) number of granted cancelations to the plurality of user devices of such purchased digital content, and (iii) number of purchases for which such digital content was forwarded by at least one of the plurality of user devices to another user device; and
   based on the determined user satisfaction indicator, performing at least one other action of transmitting a notice indicative of the user satisfaction indicator to the merchant offering such digital content item, preparing a notice indicative of the user satisfaction indicator for transmission to user devices subsequently seeking to purchase such digital content item using the payment system, limiting a number of authorization signals subsequently transmitted to the merchant for the requested digital content item, and transmitting a notice indicative of the user satisfaction indicator to a network server providing an internet search service.
32. The computer-implemented method of paragraph 31 wherein an increase in a number of granted cancelations of such digital content item has an effect of lowering the user satisfaction indicator for such digital content item.
33. The computer-implemented method of paragraph 32 wherein the user satisfaction indicator for such digital content item is based in part on a cancelation ratio determined as a number of granted user cancelations for such digital content item relative to a number of granted user cancelations for all digital content items in a predetermined category of digital content items.
34. The computer-implemented method of paragraph 33 wherein the predetermined category of digital content items is digital publishing.
35. The computer-implemented method of paragraph 31 wherein an increase in a number of purchases for which such digital content item was forwarded by the user devices to other user devices has an effect of increasing the user satisfaction indicator for such digital content item.
36. The computer-implemented method of paragraph 35 wherein an increase in a number of purchases for which there were either or both of no granted cancelations or no forwarding of the digital content item by user devices to other user devices has an effect of increasing the user satisfaction indicator for such digital content item.
37. The computer-implemented method of paragraph 36 wherein the increased number of purchases for which such digital content item was forwarded by the user devices to other user devices has a greater effect of increasing the user satisfaction indicator a same number of increased purchases of such digital content item for which there were no granted cancelations or forwarding of the digital content item to other user devices.
38. The computer-implemented method of paragraph 31 wherein in response to receiving the notice indicative of the user satisfaction indicator for the digital content, the network server providing the internet search service search service transmits such notice indicative of the user satisfaction indicator to a ranking engine, wherein the ranking engine ranks the digital content for search results to user search request based at least in part on such user satisfaction indicator.
39. A computer-implemented method for a payment system comprising the steps of:
   receiving, over a network, an identifier of a user device and information indicative of a price of a requested digital content item for purchase from a network-accessible merchant by the user device;
monitoring a total outstanding purchase balance associated with the user device;
   transmitting an authorization signal to the network-accessible merchant for the requested digital content item without concurrently requiring payment for the purchase when a total outstanding purchase balance associated with the user device does not exceed a predetermined threshold amount;
   transmitting a request signal to the user device for settlement of at least a part of the total outstanding purchase balance associated with the user device identifier when the total outstanding purchase balance exceeds the predetermined threshold amount and transmitting an authorization signal to the network-accessible merchant for the requested digital content item in response to receiving payment of at least a part of the total outstanding purchase balance associated with the user device identifier;
   determining a merchant satisfaction indicator based on at least one of tracking (i) a number of purchases of a plurality of digital content items from the merchant by a plurality of user devices including the digital content requested by the user device; (ii) a number of granted cancelations to the plurality of user devices of such purchased plurality of digital content items, (iii) a number of purchases for which at least one of the plurality of digital content items was forwarded by at least one of the plurality of user devices to another user device, and (iv) a number of user devices of the plurality of user devices that purchase more than one digital content items of the plurality of digital content items from the merchant; and
   based on the determined merchant satisfaction indicator, performing at least one other action of transmitting a notice indicative of the merchant satisfaction indicator to the merchant offering such digital content item, preparing a notice indicative of the merchant satisfaction indicator for transmission to user devices subsequently seeking to purchase one of the plurality of digital content items offered by the merchant using the payment system, limiting a number of authorization signals to be subsequently transmitted to the merchant for the requested digital content items available from the merchant, and transmitting a notice indicative of the merchant satisfaction indicator to network server providing an internet search service.
40. The computer-implemented method of paragraph 39 wherein an increase in a number of granted cancelations of digital content item purchased from the merchant lowers has an effect of lowering the merchant satisfaction indicator for such merchant.
41. The computer-implemented method of paragraph 40 wherein the merchant satisfaction indicator for the merchant is based on a cancelation ratio determined as percentage of granted cancelations to purchase of digital content items purchased from the merchant relative to percentage of granted cancelations to purchase of digital content items purchased from a plurality of merchants including the merchant in a predetermined category of digital content items.
42. The computer-implemented method of paragraph 41 wherein the predetermined category of digital content items is digital publishing.
43. The computer-implemented method of paragraph 39 wherein an increase in a number of digital content item purchases from the merchant for which such digital content items were forwarded by the user devices to other user devices has an effect of increasing the merchant satisfaction indicator for such merchant.
44. The computer-implemented method of paragraph 39 wherein an increase in a number of purchases of digital content item purchases from the merchant for which there were either or both of no granted cancelations or no forwarding of the digital content items to other user device has an effect of increasing the merchant satisfaction indicator for such merchant.
45. The computer-implemented method of paragraph 44 wherein the increased number of user devices that purchase more than one digital content item of the plurality of digital content items from the merchant has an effect of increasing the merchant satisfaction indicator for such merchant.
46. The computer-implemented method of paragraph 39 wherein in response to receiving the notice indicative of the merchant satisfaction indicator for the digital content items offered by the merchant, the network server providing the internet search service search service transmits such notice indicative of the merchant satisfaction indicator to a ranking engine, wherein the ranking engine ranks the digital content items offered by the merchant for search results based at least in part on such merchant satisfaction indicator.
47. The computer-implemented method of paragraph 39 further comprising the step of limiting the transmitted authorization signals over a predetermined period of time to a first amount in response to requests by user devices for digital content items from the merchant if its merchant satisfaction indicator is below a first predetermined threshold.
48. The computer-implemented method of paragraph 39 further comprising the step of limiting the transmitted authorization signals over a predetermined period of time to a first amount in response to requests by user devices for digital content items from the merchant if a cancelation ratio determined as percentage of granted cancelations to purchase of digital content items purchased from the merchant relative to percentage of granted cancelations to purchase of digital content items purchased from a plurality of merchants including the merchant in a predetermined category of digital content items, is exceeds a first threshold value.
49. The computer-implemented method of paragraph 48 further comprising the step of limiting the transmitted authorization signals over a predetermined period of time to a second amount in response to the determined cancelation ratio exceeds a second predetermined threshold, wherein the second amount is less than the amount and the second predetermined threshold is greater than the first predetermined threshold.

### REFERENCE SIGNS

1 Internet
10 Shopper system
20 Online shop
30 Payment system
31 Identification device
32 Interface device
33 Memory device
34 Processing device
ID Identification number
101 Step 101: payment system records the MAC address of the shopper system
102 Step 102: Is the shopper system creditworthy?
104 Step 104: The user transacts a purchase
105 Step 105: The online shop passes on an associated entry
106 Step 106: Does an account exist for the MAC address?
107 Step 107: The payment system stores the direct debit order
108 Step 108: Further purchases?
111 Step 111: Payment request
112 Step 112: Is the user paying?
113 Step 113: Block access
114 Step 114: Create account
200 Cancelation request process
210 Step 210: receive cancelation request
220 Step 220: determine CAI
230 Step 230: CAI exceeding deny threshold determination
240 Step 240: transmit deny-cancelation request to user device
Step 250: determine whether CAI falls within heightened scrutiny range
255 Step 255: transmit inquiries to user device
260 Step 260: receive responses to inquiries from user device
270 Step 270: grant or deny cancelation request
275 Step 275: transmit deny-cancelation request to user device
280 Step 280: transmit grant-cancelation request to user device and merchant
285 Step 285: adjust outstanding purchase balance associated with user device identifier
300 Method for determining and using user satisfaction indicator and merchant satisfaction indicator
310 Step 310: receive user device ID and purchase price of digital content of interest
320 Step 320: monitor outstanding balance of user device
330 Step 330: outstanding balance+purchase price≥threshold?
340 Step 340: add purchase price to outstanding balance
350 Step 350: transmit authorization signal
360 Step 360: perform payment settlement operation
370 Step 370: Payment received?
380 Step 380: determine user satisfaction indicator and/or merchant satisfaction indicator
390 Step 390: based on user satisfaction indicator and/or merchant satisfaction indicator, perform further action(s)

1. A computer-implemented method for a payment system comprising the steps of:
receiving, over a network, an identifier of a user device and information indicative of a price of a requested item for purchase from a network-accessible merchant by the user device;
determining, based on the user device identifier, a credit worthiness indicator associated with the user device;
transmitting an authorization signal to the network-accessible merchant for the requested item without concurrently requiring payment for the purchase when the creditworthiness indicator satisfies predetermined conditions;
monitoring a total outstanding purchase balance associated with the user device;
transmitting a request signal to the user device for settlement of at least a part of the total outstanding purchase balance associated with the user device identifier when the total outstanding purchase balance exceeds a predetermined threshold amount;
in response to receiving a cancelation request from the user device, performing a determination of a cancelation abuse indicator associated with the user device identifier based on a least one of a time duration since acceptance of a grant of the purchase request for the item, number of prior cancelations, time period over which the number of prior cancelations has occurred, time interval since last cancelation, the credit worthiness indicator, frequency of prior cancelations, and whether the user device identifier is included in a maintained list of abuser device identifiers; and
based on the determined cancelation abuse indicator, performing a determination of whether to grant or deny such cancelation request.

2. The computer implemented method of claim 1, wherein the step of performing a determination of a cancelation abuse indicator associated with the user device identifier such that it will be more likely that the cancelation request will be denied as the number of prior cancelations requests increases for such user device identifier.

3. The computer implemented method of claim 1, prior to the step of performing the determination of granting or denying the cancelation request, performing the step of determining whether additional information is required from the user device based on the determined cancelation abuse indicator.

4. The computer implemented method of claim 3, further comprising transmitting one or more inquiries to the user device based on a result of performing the determination of whether additional information is required from the user device prior to granting or denying such cancelation request, wherein the step of performing the determination of whether to grant or deny such cancelation request is based on at least based on additional information received from the user device.

5. The computer implemented method of claim 3, wherein the one or more inquiries to the user device is for user feedback concerning the item.

6. The computer implemented method of claim 1, wherein when granting such cancelation request, adjusting the total outstanding purchase balance associated with the user device identifier accordingly for such canceled item and transmitting a notification to the merchant of such cancelation.

7. The computer-implemented method of claim 1, wherein when such cancelation request is granted, adjusting the total outstanding purchase balance associated with the user device identifier accordingly in substantial absence of receipt of payment by the payment system, wherein said item is digital content.

8. The computer-implemented method of claim 1, wherein the total outstanding purchase balance associated with the user device identifier is adjusted in substantial absence of a signal from the user device confirming deletion of the item.

9. The computer-implemented method of claim 1 wherein the step of performing the determination of whether to grant or deny such cancelation request is performed in substantial absence of registration or login to the payment system or to the network-accessible merchant computer by a user associated with the user device.

10. The computer-implemented method of claim 1, wherein the step of performing the determination of whether to grant or deny such cancelation request is performed in substantial absence of identifying a user associated with the user device.

11. The computer-implemented method of claim 1, wherein the step of performing the determination of whether to grant or deny such cancelation request is performed in substantial absence of whether the network-accessible merchant transmitted the item to the user device, wherein the item is digital content or subscription to a digital service.

12. The computer-implemented method of claim 1, further comprising the step of inviting the user to at least one of (a) answer certain questions related or unrelated to the digital content to be canceled; (b) share his/her payment system account or certain purchased digital content with friends and/or family and providing the payment system with their contact information; (c) take a third party survey; and/or (d) take some other or further action.

13. The computer-implemented method of claim 12 wherein to the extent that the user agrees to and successfully follows through with one or more of the invited items, granting to the user at least one of (i) the user's request for cancelation; and/or (ii) a number of trust tokens.

14. The computer-implemented method of claim 13 wherein the trust tokens may be exchanged for free or discounted digital content and/or subscriptions, and/or enabling a future cancelation one or more purchases of digital content/or subscriptions, and/or other benefits.

15. The computer-implemented method of claim 1 wherein the step of performing a determination of a cancelation abuse indicator associated with the user device identifier is based on a ratio of the number of requested cancelations associated with a user device identifier in at least one of a predetermined duration of time and a session of time that the user device is interacting with a website or group of websites, relative to the number of purchases made during such session using the payment system

16. A computer-implemented method for a payment system comprising the steps of:
receiving, over a network, an identifier of a user device and information indicative of requested item for purchase from a network-accessible merchant by the user device;
determining, based on the user device identifier, a creditworthiness indicator associated with the user device;
transmitting an authorization signal to the network-accessible merchant for the requested purchase without concurrently requiring payment for the purchases, when the creditworthiness indicator satisfies predetermined conditions;
monitoring a total outstanding purchase balance associated with the user device;
transmitting a request signal to the user device for settlement of at least a part of the total outstanding purchase balance when the total outstanding balance has been accrued over a period of time that exceeds a predetermined time interval;
in response to receiving a cancelation request from the user device, performing a determination of a cancelation abuse indicator associated with the user device identifier based on a least one of a time duration since acceptance of a grant of the purchase request for the item, the total number of prior cancelations, time interval since last cancelation, the credit worthiness indicator, frequency of prior cancelations, and whether the user device identifier is included in a maintained list of abuser device identifiers; and
based on the determined cancelation abuse indicator, performing a determination of whether to grant or deny such cancelation request.

17. The computer implemented method of claim 16, wherein the step of performing a determination of a cancelation abuse indicator associated with the user device identifier such that it will be more likely that the cancelation request will be denied as the number of prior cancelations requests increases for such user device identifier.

18. The computer implemented method of claim 16, prior to the step of performing the determination of granting or denying the cancelation request, performing the step of determining whether additional information is required from the user device based on the determined cancelation abuse indicator.

19. The computer implemented method of claim 18, further comprising transmitting one or more inquiries to the user device based on a result of performing the determination of whether additional information is required from the user device prior to granting or denying such cancelation request, wherein the step of performing the determination of whether to grant or deny such cancelation request is based on at least based on additional information received from the user device.

20. The computer implemented method of claim 18, wherein the one or more inquiries to the user device is for user feedback concerning the item.

21. The computer-implemented method of claim 16, further comprising the step of inviting the user to at least one of (a) answer certain questions related or not related to the digital content to be canceled; (b) share his/her payment system account or certain purchased digital content with friends and/or family and providing the payment system with their contact information; (c) take a third party survey; and/or (d) take some other or further action.

22. The computer-implemented method of claim 21 wherein to the extent that the user agrees to and successfully follows through with one or more of the invited items, granting to the user at least one of (i) the user's request for cancelation; and/or (ii) a number of trust tokens.

23. The computer-implemented method of claim 22 wherein the trust tokens may be exchanged for free or discounted digital content and/or subscriptions, and/or enabling a future right to cancel one or more purchases of digital content, and/or other benefits.

24. The computer implemented method of claim 16, wherein when granting such cancelation request, adjusting the total outstanding purchase balance associated with the user device identifier accordingly for such canceled item and transmitting a notification to the merchant of such cancelation.

25. The computer-implemented method of claim 24, wherein when such cancelation request is granted, adjusting the total outstanding purchase balance associated with the user device identifier accordingly in substantial absence of receipt of payment by the payment system, wherein said item is digital content.

26. The computer-implemented method of claim 24, wherein the total outstanding purchase balance associated with the user device identifier is adjusted in substantial absence of a signal from the user device confirming deletion of the item.

27. The computer-implemented method of claim 16 wherein the step of performing the determination of whether to grant or deny such cancelation request is performed in substantial absence of registration or login to the payment system or to the network-accessible merchant computer by a user associated with the user device.

28. The computer-implemented method of claim 16, wherein the step of performing the determination of whether to grant or deny such cancelation request is performed in substantial absence of identifying a user associated with the user device.

29. The computer-implemented method of claim 16, wherein the step of performing the determination of whether to grant or deny such cancelation request is performed in substantial absence of the network-accessible merchant transmitted the item to the user device, and wherein the item is digital content or subscription to a digital service.

30. The computer-implemented method of claim 16 wherein the step of performing a determination of a cancelation abuse indicator associated with the user device identifier is based on a ratio of the number of requested cancelations associated with a user device identifier in at least one of a predetermined duration of time and a session of time that the user device is interacting with a website or group of websites, relative to the number of purchases made during such session using the payment system

31. A computer-implemented method for a payment system comprising the steps of:
receiving, over a network, an identifier of a user device and information indicative of a price of a requested digital content item for purchase from a network-accessible merchant by the user device;
monitoring a total outstanding purchase balance associated with the user device;
transmitting an authorization signal to the network-accessible merchant for the requested digital content item without concurrently requiring payment for the purchase when a total outstanding purchase balance associated with the user device does not exceed a predetermined threshold amount;
transmitting a request signal to the user device for settlement of at least a part of the total outstanding purchase balance associated with the user device identifier when the total outstanding purchase balance exceeds the predetermined threshold amount and transmitting an authorization signal to the network-accessible merchant for the requested digital content item in response to receiving payment of at least a part of the total outstanding purchase balance associated with the user device identifier;
determining a user satisfaction indicator for the purchased digital content item based on at least one of tracking (i) number of purchases of the digital content item by a plurality of user devices including the user device; (ii) number of granted cancelations to the plurality of user devices of such purchased digital content, and (iii) number of purchases for which such digital content was forwarded by at least one of the plurality of user devices to another user device; and
based on the determined user satisfaction indicator, performing at least one other action of transmitting a notice indicative of the user satisfaction indicator to the merchant offering such digital content item, preparing a notice indicative of the user satisfaction indicator for transmission to user devices subsequently seeking to purchase such digital content item using the payment system, limiting a number of authorization signals subsequently transmitted to the merchant for the requested digital content item, and transmitting a notice indicative of the user satisfaction indicator to a network server providing an internet search service.

32. The computer-implemented method of claim 31 wherein an increase in a number of granted cancelations of such digital content item has an effect of lowering the user satisfaction indicator for such digital content item.

33. The computer-implemented method claim 32 wherein the user satisfaction indicator for such digital content item is based in part on a cancelation ratio determined as a number of granted user cancelations for such digital content item relative to a number of granted user cancelations for all digital content items in a predetermined category of digital content items.

34. The computer-implemented method of claim 33 wherein the predetermined category of digital content items is digital publishing.

35. The computer-implemented method of claim 31 wherein an increase in a number of purchases for which such digital content item was forwarded by the user devices to other user devices has an effect of increasing the user satisfaction indicator for such digital content item.

36. The computer-implemented method of claim 35 wherein an increase in a number of purchases for which there were either or both of no granted cancelations or no forwarding of the digital content item by user devices to other user devices has an effect of increasing the user satisfaction indicator for such digital content item.

37. The computer-implemented method of claim 36 wherein the increased number of purchases for which such digital content item was forwarded by the user devices to other user devices has a greater effect of increasing the user satisfaction indicator a same number of increased purchases of such digital content item for which there were no granted cancelations or forwarding of the digital content item to other user devices.

38. The computer-implemented method of claim 31 wherein in response to receiving the notice indicative of the user satisfaction indicator for the digital content, the network server providing the internet search service search service transmits such notice indicative of the user satisfaction indicator to a ranking engine, wherein the ranking engine ranks the digital content for search results to user search request based at least in part on such user satisfaction indicator.

39. A computer-implemented method for a payment system comprising the steps of:
receiving, over a network, an identifier of a user device and information indicative of a price of a requested digital content item for purchase from a network-accessible merchant by the user device;
monitoring a total outstanding purchase balance associated with the user device;
transmitting an authorization signal to the network-accessible merchant for the requested digital content item without concurrently requiring payment for the purchase when a total outstanding purchase balance associated with the user device does not exceed a predetermined threshold amount;
transmitting a request signal to the user device for settlement of at least a part of the total outstanding purchase balance associated with the user device identifier when the total outstanding purchase balance exceeds the predetermined threshold amount and transmitting an authorization signal to the network-accessible merchant for the requested digital content item in response to receiving payment of at least a part of the total outstanding purchase balance associated with the user device identifier;
determining a merchant satisfaction indicator based on at least one of tracking (i) a number of purchases of a plurality of digital content items from the merchant by a plurality of user devices including the digital content requested by the user device; (ii) a number of granted cancelations to the plurality of user devices of such purchased plurality of digital content items, (iii) a number of purchases for which at least one of the plurality of digital content items was forwarded by at least one of the plurality of user devices to another user device, and (iv) a number of user devices of the plurality of user devices that purchase more than one digital content items of the plurality of digital content items from the merchant; and
based on the determined merchant satisfaction indicator, performing at least one other action of transmitting a notice indicative of the merchant satisfaction indicator to the merchant offering such digital content item, preparing a notice indicative of the merchant satisfaction indicator for transmission to user devices subsequently seeking to purchase one of the plurality of digital content items offered by the merchant using the payment system, limiting a number of authorization signals to be subsequently transmitted to the merchant for the requested digital content items available from the merchant, and transmitting a notice indicative of the merchant satisfaction indicator to network server providing an internet search service.

40. The computer-implemented method of claim 39 wherein an increase in a number of granted cancelations of digital content item purchased from the merchant lowers has an effect of lowering the merchant satisfaction indicator for such merchant.

41. The computer-implemented method of claim 40 wherein the merchant satisfaction indicator for the merchant is based on a cancelation ratio determined as percentage of granted cancelations to purchase of digital content items purchased from the merchant relative to percentage of granted cancelations to purchase of digital content items purchased from a plurality of merchants including the merchant in a predetermined category of digital content items.

42. The computer-implemented method of claim 41 wherein the predetermined category of digital content items is digital publishing.

43. The computer-implemented method of claim 39 wherein an increase in a number of digital content item purchases from the merchant for which such digital content items were forwarded by the user devices to other user devices has an effect of increasing the merchant satisfaction indicator for such merchant.

44. The computer-implemented method of claim 39 wherein an increase in a number of purchases of digital content item purchases from the merchant for which there were either or both of no granted cancelations or no forwarding of the digital content items to other user device has an effect of increasing the merchant satisfaction indicator for such merchant.

45. The computer-implemented method of claim 44 wherein the increased number of user devices that purchase more than one digital content item of the plurality of digital content items from the merchant has an effect of increasing the merchant satisfaction indicator for such merchant.

46. The computer-implemented method of claim 39 wherein in response to receiving the notice indicative of the merchant satisfaction indicator for the digital content items offered by the merchant, the network server providing the internet search service search service transmits such notice indicative of the merchant satisfaction indicator to a ranking engine, wherein the ranking engine ranks the digital content items offered by the merchant for search results based at least in part on such merchant satisfaction indicator.

47. The computer-implemented method of claim 39 further comprising the step of limiting the transmitted authorization signals over a predetermined period of time to a first amount in response to requests by user devices for digital content items from the merchant if its merchant satisfaction indicator is below a first predetermined threshold.

48. The computer-implemented method of claim 39 further comprising the step of limiting the transmitted authorization signals over a predetermined period of time to a first amount in response to requests by user devices for digital content items from the merchant if a cancelation ratio determined as percentage of granted cancelations to purchase of digital content items purchased from the merchant relative to percentage of granted cancelations to purchase of digital content items purchased from a plurality of merchants including the merchant in a predetermined category of digital content items, is exceeds a first threshold value.

49. The computer-implemented method of claim 48 further comprising the step of limiting the transmitted authorization signals over a predetermined period of time to a second amount in response to the determined cancelation ratio exceeds a second predetermined threshold, wherein the second amount is less than the amount and the second predetermined threshold is greater than the first predetermined threshold.
